(19) United States
(12) Patent Application Publication
(10) Pub. No.: US 2017/0341596 A1
(43) Pub. Date: Nov. 30, 2017

(54) CONTROL SYSTEM FOR A MULTIFUNCTIONAL ELECTRONIC MODULE IN A MOTOR VEHICLE

(71) Applicant: Dura Operating, LLC, Auburn Hills, MI (US)

(72) Inventor: Aaron Evans Thompson, Grand Blanc, MI (US)

(21) Appl. No.: 15/165,055

(22) Filed: May 26, 2016

(51) Int. Cl. B60R 11/04; H04N 5/232; H04N 7/18; B60R 16/03; B60R 11/00

(52) U.S. Cl. CPC B60R 11/04; H04N 7/183; B60R 16/03; H04N 5/23241; B60R 2011/004

(57) ABSTRACT

A system includes a module mounted to an exterior of a motor vehicle, the module having a camera mounted within the module, an indicator mounted within the module for optically communicating information external to the motor vehicle, and a module control. The module control unit includes a first microcontroller connected to the indicator for commanding the indicator to communicate information, a first data transmission device connected to the first microcontroller, and a power supply connected to the camera and the indicator for supplying power to the camera and the indicator. An external electronic control unit is disposed in the motor vehicle external to the module. A connection link is connected to the module and the external electronic control unit interleaves both data communication and power.

### FIELD

The invention relates generally to a control system for a multifunctional electronic module for a motor vehicle, and more particularly to a control system for a multifunctional electronic module that communicates power and data between the module and the motor vehicle controller.

### BACKGROUND

The statements in this section merely provide background information related to the present disclosure and may or may not constitute prior art.

Motor vehicles have been designed with increasingly advanced technologies aimed at improving the safety, efficiency, and performance of the motor vehicle. Examples of such technologies include advanced driver assistance systems and human machine interface systems. Generally, advanced driver assistance systems automate, adapt, or enhance vehicle systems in order to increase vehicle safety and/or operator driving performance. Advanced driver assistance systems are designed to avoid accidents by offering technologies that alert the driver to potential problems or to avoid collisions by implementing safeguards, such as autonomously controlling the vehicle. Operator driving performance may be improved by using features that enhance certain systems, such as automated lighting, automated parking, adaptive cruise control, automated braking, or improved blind spot elimination using camera technology. Human machine interface systems generally include systems that provide graphics-based visualization of a control system, either to the user of the motor vehicle or to an individual external to the motor vehicle. An example of such a device is a projector system that projects images onto or around the motor vehicle to communicate information regarding the status of the motor vehicle.

The addition of these advanced technologies to the motor vehicle in turn requires a range of additional hardware to implement these systems. Examples of this hardware include rear-view side cameras, surround-view cameras, sensors, projectors, etc. Thus, while advanced driver assistance systems and human machine interface systems are useful for their intended purpose, there is a constant challenge in packaging and controlling these systems efficiently while not degrading the drivability, fuel efficiency, and appearance of the motor vehicle. Accordingly, a need exists for a system that effectively powers and controls these advanced technologies.

### SUMMARY

A system for controlling a multifunctional electronic module in for motor vehicle is provided. The system includes a module mounted to an exterior of the motor vehicle, the module having a camera mounted within the module, an indicator mounted within the module for optically communicating information external to the motor vehicle, and a module control. The module control unit includes a first microcontroller connected to the indicator for commanding the indicator to communicate information, a first data transmission device connected to the first microcontroller, and a power supply connected to the camera and the indicator for supplying power to the camera and the indicator. An external electronic control unit is disposed in the motor vehicle external to the module, the external electronic control unit having a second microcontroller, a second data transmission device connected to the second microcontroller, and a power source. A connection link is connected to the module and the external electronic control unit that interleaves both data communication between the first data transmission device and the second data transmission device and power from the power source to the power supply.

In one aspect, the indicator is a projector or a turn signal.

In another aspect, the camera is a rear-facing camera or a side surround camera.

In another aspect, only one connection link is connected between the module and the external electronic control unit.

In another aspect, the module control unit includes memory connected to the first microcontroller for storing information related to the camera and to the indicator.

In another aspect, the information includes camera calibration data, camera configuration data, manufacturing data, and indicator images.

In another aspect, the module is pivotally mounted to the motor vehicle and includes a motor for pivoting the module, wherein the module control unit further includes a motor driver connected to the first microcontroller, the power supply, and the motor, and wherein the first microcontroller selectively communicates a command to the motor driver to pivot the module and the motor driver powers and drives the motor upon receipt of the command.

In another aspect, the second microcontroller processes and transforms data from the camera to generate an image view.

In another aspect, a display device is disposed in the motor vehicle and connected to the external electronic control unit, wherein the display device displays the image view generated from the second microcontroller.

In another aspect, the first transmission device serializes data from the camera and the first microcontroller and communicates the serialized data to the second transmission device, and the second transmission device deserializes the serialized data.

In another aspect, the second transmission device serializes second data from the second microcontroller including camera and indicator command data and communicates the serialized second data to the first transmission device, and the first data transmission device deserializes the second serialized data.

A system for controlling an armature in a motor vehicle is also provided. The system includes an armature pivotally mounted to an exterior of the motor vehicle, the armature having a camera mounted within the armature, a motor for pivoting the armature between an extended position and a closed position, an armature control unit having a first microcontroller connected to the motor for commanding the motor to pivot the armature, a first data transmission device connected to the first microcontroller, and a power supply connected to the camera and the motor for supplying power to the camera and the motor. An external electronic control unit is disposed in the motor vehicle external to the armature, the external electronic control unit having a second microcontroller, a second data transmission device connected to the second microcontroller, and a power source. A connection link is disposed between the armature and the external electronic control unit that carries both data communication between the first data transmission device and the second data transmission device and power from the power source to the power supply.

In one aspect, the connection link is connected to the first transmission device and the power supply at one end and connected to the second transmission device and power source at another end.

In another aspect, the camera is a rear-view camera and the armature control unit further includes a rear-view camera circuit connected between the rear-view camera and the first transmission device.

In another aspect, a surround-view camera is mounted within the armature, and the armature control unit further includes a surround-view camera circuit connected between the surround-view camera and the first transmission device.

In another aspect, a projector is mounted within the armature, and the projector is connected to the first microcontroller for receiving commands and to the power supply for receiving power.

In another aspect, a turn signal is mounted in the armature, and the armature control unit further includes a turn signal driver connected to the first microcontroller for receiving commands and to the power supply for receiving power.

In another aspect, the armature control unit includes memory connected to the first microcontroller for storing camera calibration data, camera configuration data, manufacturing data, and projector images.

In another aspect, the first transmission device serializes and communicates rear-view camera image data and surround-view camera image data to the second transmission device via the connection link for deserialization by the second transmission device, and the second transmission device serializes and communicates rear-view camera control data, surround-view camera control data, turn signal control data, motor control data, and projector control data to the first transmission device via the connection link for deserialization by the first transmission device.

A system for a motor vehicle is also provided that includes an armature pivotally mounted to the motor vehicle, the armature having a camera mounted within the armature that generates image data, a turn signal mounted within the armature, a motor for pivoting the armature between an extended position and a closed position, and an armature control unit having a first microcontroller connected to the motor, the turn signal, and the camera, wherein the first microcontroller commands the motor to pivot the armature, commands the turn signal to activate or deactivate, and configures the camera based on received control data, a first data transmission device connected to the first microcontroller, and a power supply connected to the camera, the turn signal, and the motor for supplying power to the camera, the turn signal, and the motor. An external electronic control unit is disposed in the motor vehicle external to the armature, the external electronic control unit having a second microcontroller for generating the control data including a camera control data, a turn signal control data, and a motor control data, a second data transmission device connected to the second microcontroller, and a power source. A connection link is disposed between the armature and the external electronic control unit that carries both the image data and the control data between the first data transmission device and the second data transmission device and power from the power source to the power supply. The second transmission device serializes and communicates the control data to the first transmission device via the connection link, the first transmission device deserializes the control data, and the first microcontroller commands the camera, turn signal, and motor based on the control data. The first transmission device serializes and communicates the image data to the second transmission device via the connection link for deserialization by the second transmission device, and the second microcontroller processes the image data.

Further aspects, examples, and advantages will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a top view of an exemplary motor vehicle having a control system for a plurality of multifunctional electronic modules according to the principles of the present disclosure;

FIG. 2A is a top, back perspective view of an exemplary multifunctional electronic module for use with the control system in a first position;

FIG. 2B is a top, back perspective view of the exemplary multifunctional electronic module in a second position;

FIG. 2C is a bottom, back perspective view of the exemplary multifunctional electronic module in the second position;

FIG. 3 is a schematic diagram of the architecture of the control system for controlling the multifunctional electronic module; and

FIG. 4 is a schematic diagram of the control system for controlling the multifunctional electronic module.

### DETAILED DESCRIPTION

The following description is merely exemplary in nature and is not intended to limit the present disclosure, application, or uses.

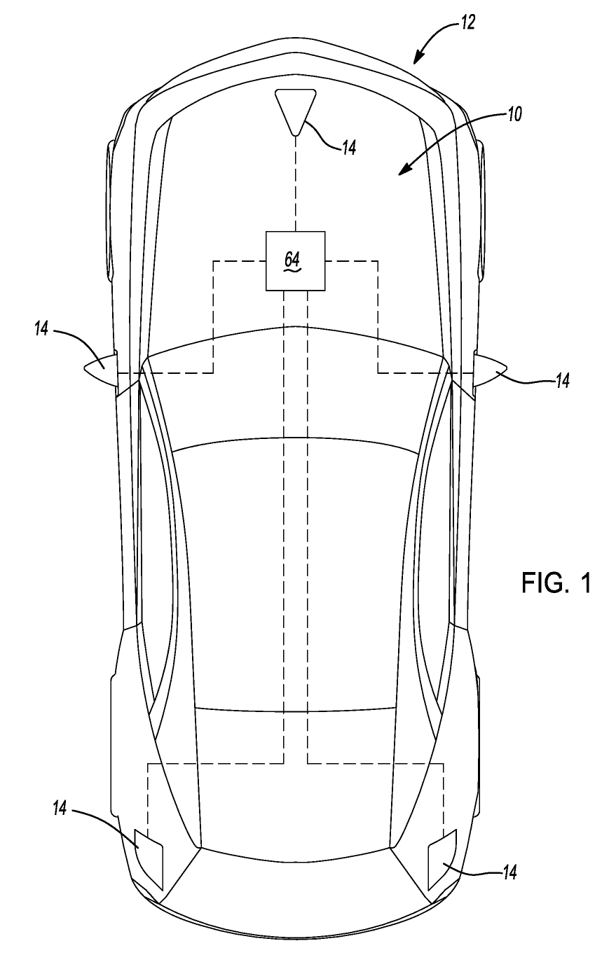

With reference to FIG. 1, a control system according to the principles of the present disclosure is illustrated and generally indicated by reference number 10. The control system 10 is used with an exemplary motor vehicle 12 and is configured to power and control one or more of a plurality of multifunctional electronic modules 14 mounted to the motor vehicle 12. In the example provided, the motor vehicle 12 is illustrated as a passenger vehicle. However, the motor vehicle 12 may be a truck, sport utility vehicle, van, motor home, or any other type of vehicle without departing from the scope of the present disclosure. The multifunctional electronic modules 14 are modular components connected to the motor vehicle 12 that house multiple electronic devices as part of an advanced driver assistance system or human machine interface system. The multifunctional electronic modules 14 may be mounted on various locations of the motor vehicle 12, as illustrated in FIG. 1. The multifunctional electronic modules 14 may be fixedly connected to the motor vehicle 12 or pivotally mounted to the motor vehicle 12.

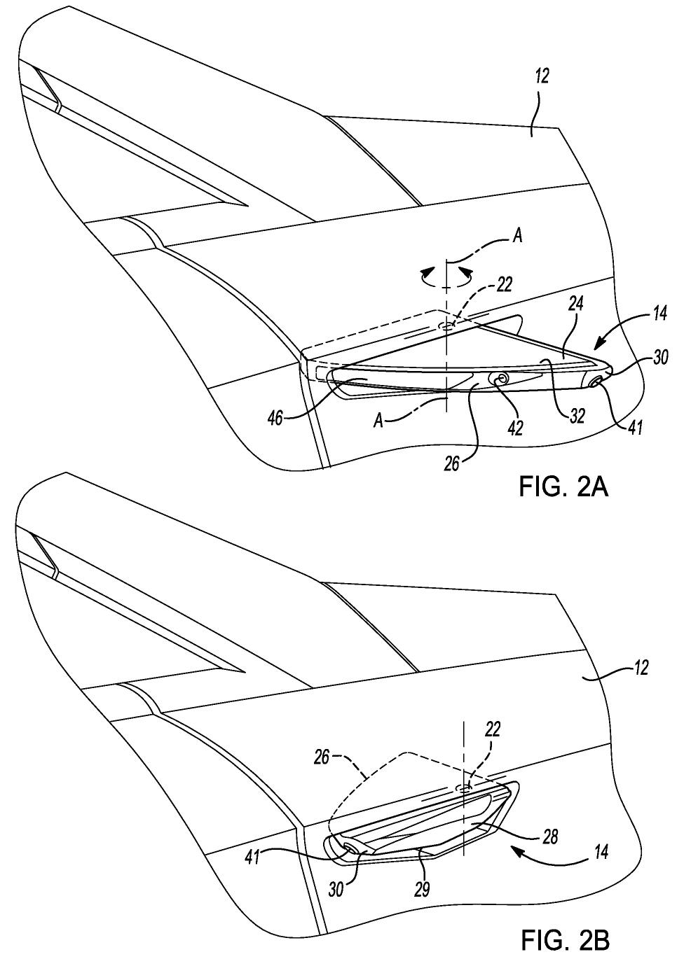

Turning to FIGS. 2A-C, an example of a multifunctional electronic module 14 is shown in greater detail. The multifunctional electronic module 14 is an armature pivotally mounted to the motor vehicle 12 at a pivot point 22. The multifunctional electronic module 14 is pivoted at the pivot point 22 about an axis A-A between a first position or concealed position, shown in FIG. 2A, and a second position or extended position, shown in FIGS. 2B-2C. The multifunctional electronic module 14 includes a housing 24 having an inner or back surface 26 and an outer or forward surface 28. A portion of the back surface 26 or an end surface 30 connects the back surface 26 and the forward surface 28. The end surface 30 is angled with respect to the back surface 26 and the forward surface 28. The housing 24 further includes a top surface 32 and a bottom surface 34, shown in FIG. 2C. The top and bottom surfaces 32, 34 are substantially planar and perpendicular to the axis A-A.

In the first or concealed position illustrated in FIG. 2A, the multifunctional electronic module 14 is substantially hidden within the motor vehicle 12 so that the back surface 26 is concealed while only the forward surface 28 is visible relative to an exterior of the motor vehicle 12. Preferably, the forward surface 28 is substantially flush with an outer trim of the motor vehicle 12. In the second or extended position illustrated in FIGS. 2B-2C, the multifunctional electronic module 14 is extended out from the motor vehicle 12 so that the back surface 26 faces rearward relative to the motor vehicle 12, the forward surface 28 faces forward relative to the motor vehicle 12, and the end surface 30 extends out away from the outer body trim of the motor vehicle 12.

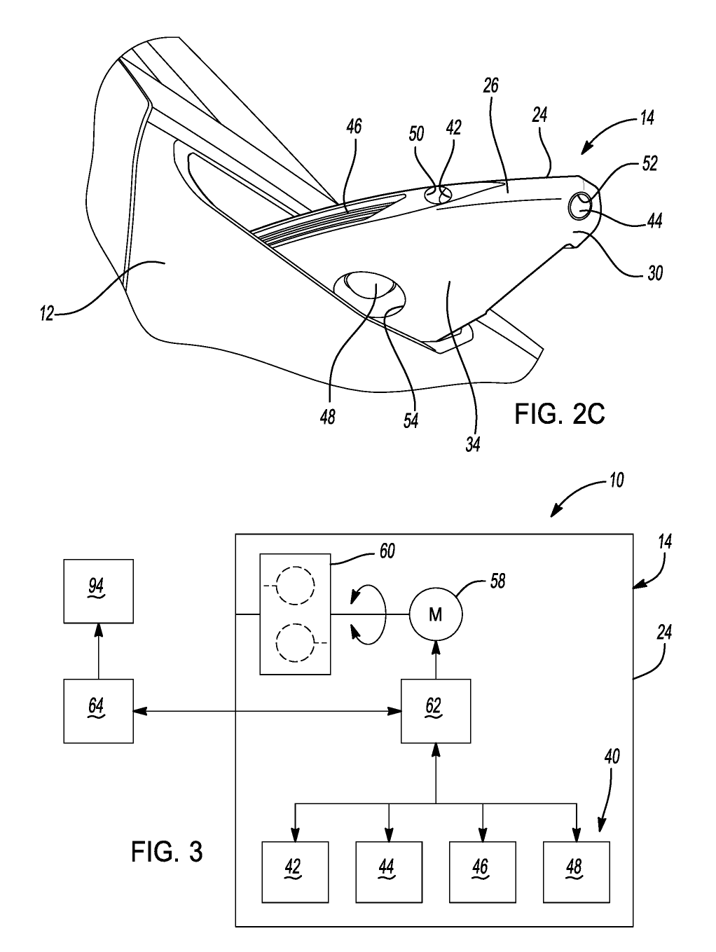

Turning to FIG. 3, and with continued reference to FIGS. 2A-2C, the multifunctional electronic module 14 includes a plurality of electronic devices 40 housed within the housing 24. The electronic devices 40 may generally be categorized into sensors for capturing information and emitters, indicators, or human machine interface (HMI) systems that provide information regarding a status of the motor vehicle 12. The sensors operate to sense multiple sets of data for use by an operator or control unit of the motor vehicle while the emitters, indicators, and HMI systems emits or projects multiple sets of information to an observer external to the motor vehicle. Various combinations of electronic devices 40 may be housed within the multifunctional electronic module 14 depending on the functionality desired. However, in a preferred embodiment, the plurality of electronic devices 40 includes a rear-view side camera 42, a surround-view camera 44, a turn signal 46, and a projector 48. Alternatively, the rear-view side camera 42 may be replaced with a wide-angle rear-view camera or a front-view camera, depending on the location of the multifunctional electronic module 14 on the motor vehicle 12.

The rear-view side camera 42 is disposed within an aperture 50 in the housing 24 of the multifunctional electronic module 14 disposed on the back surface 26. The rear-view side camera 42 is configured to capture rear-view images relative to the motor vehicle 12 when the multifunctional electronic module 14 is extended. The surround-view camera 44 is disposed within an aperture 52 in the housing 24 on the end surface 30. The surround-view camera 44 is configured to capture a wide field of view around the side of the motor vehicle 12 when the multifunctional electronic module 14 is extended. The field of view captured by the surround-view camera 44 is combined with other fields of view from other cameras to generate a surround-view of the motor vehicle 12. The turn signal 46 is disposed on the back surface 26 and may be activated to indicate a desired turn. The projector 48 is disposed in an aperture 54 formed in the bottom surface 34 of the multifunctional electronic module 14. The projector 48 is configured to project an image or a dynamic image on a surface external to the motor vehicle 12. Examples of images include turn signal arrows, messages, etc.

The multifunctional electronic module 14 further includes an actuator 58 housed within the housing 24 to move the multifunctional electronic module 14 between the concealed and extended positions. The actuator 58 is preferably an electric motor and, upon command, actuates a pivot connection 60 that articulates the multifunctional electronic module 14 about the pivot point 22.

Each of the electronic devices 40 and the actuator 58 is in electronic communication with a module control unit (MCU) 62. The MCU 62 is housed within the multifunctional electronic module 14. The MCU 62 is in electronic communication with a vehicle control unit (VCU) 64 disposed in the motor vehicle 12.

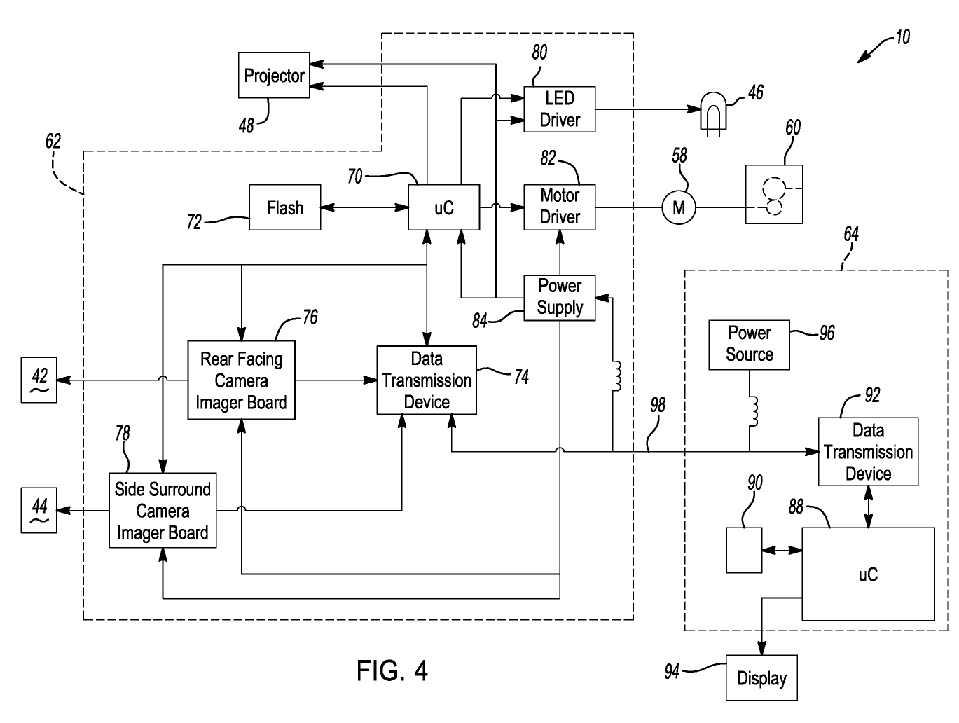

Turning now to FIG. 4, the control system 10, including the MCU 62 and the VCU 64, is illustrated in further detail. The MCU 62 a non-generalized, electronic control device having a preprogrammed digital computer or MCU microprocessor 70. The MCU microprocessor 70 is in bi-directional electronic communication with a memory or non-transitory computer readable medium 72. The memory 72 is used to store data such as control logic or instructions, images for the projector 48, calibration data for the rear-view side camera 42 and the surround-view camera 44, configuration data for the electronic devices 40, and manufacturing data for the electronic devices 40.

The MCU microprocessor 70 is also in bi-directional electronic communication with a MCU data transmission device 74, a rear-view side camera imager board 76, and a surround-view camera imager board 78. The MCU microprocessor 70 is in one-way electronic communication with a light emitting diode (LED) driver 80, a motor driver 82, and the projector 48.

The MCU data transmission device 74 is a serializer and deserializer that communicates electronically with the VCU 64. In the serializer process, the MCU data transmission device 74 translates data into a format that is transmittable over a network connection link which can then be translated or extracted back into a clone of the original data structure. In the deserializer process, the MCU data transmission device 74 extracts formatted data that was received over the network connection link.

The rear-view side camera imager board 76 is in electronic communication with the rear-view side camera 42. The rear-view side camera imager board 76 is an electronic circuit configured to command and control the rear-view side camera 42 based on control commands received from the MCU microprocessor 70. The surround-view camera imager board 78 is in electronic communication with the surround-view camera 44. The surround-view camera imager board 78 is an electronic circuit configured to command and control the surround-view camera 44 based on control commands received from the MCU microprocessor 70. Both the rear-view side camera imager board 76 and the surround-view camera imager board 78 are in one-way electronic communication with the MCU data transmission device 74 and to communicate image data directly to the MCU data transmission device 74 for serialization.

The LED driver 80 is connected to the turn signal 46 and, upon receipt of a command from the MCU microprocessor 70, activates or deactivates the turn signal 46. Thus, the LED driver 80 may be a switch or other type of controller. The motor driver 82 is connected to the actuator 58 and, upon receipt of a command from the MCU microprocessor 70, controls the actuator 58 in order to extend or conceal the multifunctional electronic module 14. The motor driver 82 may be of various types and is configured to start and stop the actuator 58, select a forward or reverse rotation, select and regulate a speed of actuation, regulate or limit the torque, protect against faults, etc.

The MCU 62 further includes a power supply circuit 84 that provides power to each of the MCU microprocessor 70, the rear-view side camera imager board 76, the surround-view camera imager board 78, the LED driver 80, the motor driver 82, and the projector 48.

The VCU 64 a non-generalized, electronic control device having a preprogrammed digital computer or VCU microprocessor 88. The VCU 64 may be an engine control module, transmission control module, body control module, or a dedicated control module, etc. The VCU microprocessor 88 is in bi-directional electronic communication with a memory or non-transitory computer readable medium 90, a VCU data transmission device 92, and a display device 94. The VCU data transmission device 92 is a serializer and deserializer that communicates electronically with the MCU 62. In the serializer process, the VCU data transmission device 92 translates data into a format that is transmittable over a network connection link which can then be translated or extracted back into a clone of the original data structure. In the deserializer process, the VCU data transmission device 92 extracts formatted data that was received over the network connection link. The display device 94 is located in the motor vehicle 12 and is viewable by operator of the motor vehicle 12. The display device 94 may be located in an instrument panel, heads-up-display, or dashboard of the motor vehicle 12 or may be a separate, standalone display screen. The VCU 64 also includes a power source 96. The power source 96 draws power from the motor vehicle 12.

The MCU 62 and the VCU 64 communicate via only one, single wired connection or network connection link 98. It should be appreciated that the wired connection 98 may include multiple serial connections but that no parallel connections are needed. The wired connection 98 may be a coaxial cable or other connection link that is able to communicate power interleaved with serialized data. The wired connection 98 is connected to the MCU data transmission device 74 and the power supply circuit 84 in the MCU 62 and connected to the VCU data transmission device 92 and the power source 96 in the VCU 64.

During operation of the control system 10, operational request commands are generated by the VCU microprocessor 88 and communicated to the VCU data transmission device 92. The VCU data transmission device 92 serializes the request commands. The serialized request commands are interleaved with power provided by the power source 96 and communicated over the wired connection 98 to the MCU 62. The power communicates to the power supply circuit 84 and powers the electronic devices 40 and the motor driver 82. The serialized request commands are received by the MCU data transmission device 74 and deserialized. These request commands are received by the MCU microprocessor 70 which then issues commands to the various electronic devices of the multifunctional electronic module 14. These commands may include operating the cameras 42, 44, extending or concealing the multifunctional electronic module 14, projecting information using the projector 48, and/or activating the turn signal 46. Image data from the camera imager boards 76, 78 is communicated directly to the MCU data transmission device 74 which serializes this image data. The serialized image data is then interleaved with the power and serialized request commands from the VCU 64 and communicated via the wired connection 98 to the VCU data transmission device 92. The VCU data transmission device 92 deserializes the image data which is communicated to the VCU microprocessor 88. The VCU microprocessor 88 then performs image processing, image transformation, and view generation to ultimately display camera images on the display device 94.

The description of the invention is merely exemplary in nature and variations that do not depart from the gist of the invention are intended to be within the scope of the invention. Such variations are not to be regarded as a departure from the spirit and scope of the invention.

1. A system for a motor vehicle comprising:
a module mounted to an exterior of the motor vehicle, the module having:
a camera mounted within the module;
an indicator mounted within the module for optically communicating information external to the motor vehicle;
a module control unit having:
a first microcontroller connected to the indicator for commanding the indicator to communicate information;
a first data transmission device connected to the first microcontroller; and
a power supply connected to the camera and the indicator for supplying power to the camera and the indicator;
an external electronic control unit disposed in the motor vehicle external to the module, the external electronic control unit having:
a second microcontroller;
a second data transmission device connected to the second microcontroller; and
a power source; and
a connection link connected to the module and the external electronic control unit that interleaves both data communication between the first data transmission device and the second data transmission device and power from the power source to the power supply.

2. The system of claim 1 wherein the indicator is a projector or a turn signal.

3. The system of claim 1 wherein the camera is a rear-facing camera or a side surround camera.

4. The system of claim 1 wherein only one connection link is connected between the module and the external electronic control unit.

5. The system of claim 1 wherein the module control unit includes memory connected to the first microcontroller for storing information related to the camera and to the indicator.

6. The system of claim 5 wherein the information includes camera calibration data, camera configuration data, manufacturing data, and indicator images.

7. The system of claim 1 wherein the module is pivotally mounted to the motor vehicle and includes a motor for pivoting the module, wherein the module control unit further includes a motor driver connected to the first microcontroller, the power supply, and the motor, and wherein the first microcontroller selectively communicates a command to the motor driver to pivot the module and the motor driver powers and drives the motor upon receipt of the command.

8. The system of claim 1 wherein the second microcontroller processes and transforms data from the camera to generate an image view.

9. The system of claim 8 further comprising a display device disposed in the motor vehicle and connected to the external electronic control unit, wherein the display device displays the image view generated from the second microcontroller.

10. The system of claim 1 wherein the first transmission device serializes data from the camera and the first microcontroller and communicates the serialized data to the second transmission device, and the second transmission device deserializes the serialized data.

11. The system of claim 10 wherein the second transmission device serializes second data from the second microcontroller including camera and indicator command data and communicates the serialized second data to the first transmission device, and the first data transmission device deserializes the second serialized data.

12. A system for a motor vehicle comprising:
an armature pivotally mounted to an exterior of the motor vehicle, the armature having:
a camera mounted within the armature;
a motor for pivoting the armature between an extended position and a closed position;
an armature control unit having:
a first microcontroller connected to the motor for commanding the motor to pivot the armature;
a first data transmission device connected to the first microcontroller; and
a power supply connected to the camera and the motor for supplying power to the camera and the motor;
an external electronic control unit disposed in the motor vehicle external to the armature, the external electronic control unit having:
a second microcontroller;
a second data transmission device connected to the second microcontroller; and
a power source; and
a connection link between the armature and the external electronic control unit that carries both data communication between the first data transmission device and the second data transmission device and power from the power source to the power supply.

13. The system of claim 12 wherein the connection link is connected to the first transmission device and the power supply at one end and connected to the second transmission device and power source at another end.

14. The system of claim 12 wherein the camera is a rear-view camera and the armature control unit further includes a rear-view camera circuit connected between the rear-view camera and the first transmission device.

15. The system of claim 14 further comprising a surround-view camera mounted within the armature, and wherein the armature control unit further includes a surround-view camera circuit connected between the surround-view camera and the first transmission device.

16. The system of claim 15 further comprising a projector mounted within the armature, and wherein the projector is connected to the first microcontroller for receiving commands and to the power supply for receiving power.

17. The system of claim 16 further comprising a turn signal mounted in the armature, and wherein the armature control unit further includes a turn signal driver connected to the first microcontroller for receiving commands and to the power supply for receiving power.

18. The system of claim 17 wherein the armature control unit includes memory connected to the first microcontroller for storing camera calibration data, camera configuration data, manufacturing data, and projector images.

19. The system of claim 18 wherein the first transmission device serializes and communicates rear-view camera image data and surround-view camera image data to the second transmission device via the connection link for deserialization by the second transmission device, and the second transmission device serializes and communicates rear-view camera control data, surround-view camera control data, turn signal control data, motor control data, and projector control data to the first transmission device via the connection link for deserialization by the first transmission device.

20. A system for a motor vehicle comprising:
an armature pivotally mounted to the motor vehicle, the armature having:
a camera mounted within the armature that generates image data;
a turn signal mounted within the armature;
a motor for pivoting the armature between an extended position and a closed position; and
an armature control unit having:
a first microcontroller connected to the motor, the turn signal, and the camera, wherein the first microcontroller commands the motor to pivot the armature, commands the turn signal to activate or deactivate, and configures the camera based on received control data;
a first data transmission device connected to the first microcontroller; and
a power supply connected to the camera, the turn signal, and the motor for supplying power to the camera, the turn signal, and the motor;
an external electronic control unit disposed in the motor vehicle external to the armature, the external electronic control unit having:
a second microcontroller for generating the control data including a camera control data, a turn signal control data, and a motor control data;
a second data transmission device connected to the second microcontroller; and
a power source; and
a connection link between the armature and the external electronic control unit that carries both the image data and the control data between the first data transmission device and the second data transmission device and power from the power source to the power supply,
wherein the second transmission device serializes and communicates the control data to the first transmission device via the connection link, the first transmission device deserializes the control data, and the first microcontroller commands the camera, turn signal, and motor based on the control data, and wherein the first transmission device serializes and communicates the image data to the second transmission device via the connection link for deserialization by the second transmission device, and the second microcontroller processes the image data.
